(19) United States
(12) Patent Application Publication
(10) Pub. No.: US 2021/0050603 A1
(43) Pub. Date: Feb. 18, 2021

(54) BIPOLAR PLATE FOR ELEMENTS OF A FUEL CELL UNIT, METHOD FOR PRODUCING SAID BIPOLAR PLATE, FUEL CELL UNIT INCLUDING SAME, AND FUEL CELL INCLUDING SAID UNIT

(71) Applicants: APERAM, LUXEMBOURG (LU); SOGEPA Société wallonne de Gestion et de Participations, LIEGE (BE)

(72) Inventors: Pauline GIRARDON, LOOS (FR); Sébastien TAHON, WITTES (FR); Jean-Michel DAMASSE, LOMME (FR); Hughes CORNIL, MARCHIN (BE); Olivier HENROTTE, Ouffet (BE); Alain PIMARD, Pont de Roide (FR)

(21) Appl. No.: 16/965,561

(22) PCT Filed: Jan. 29, 2018
(86) PCT No.: PCT/IB2018/050526

§ 371 Date: Jul. 28, 2020

(51) Int. Cl. H01M 8/0208; H01M 8/0228; H01M 8/0226

(52) U.S. Cl. CPC H01M 8/0208; H01M 8/0226; H01M 8/0228

(57) ABSTRACT

Bipolar plate for assembling the elements of a fuel cell unit, consisting of a stainless-steel substrate (1) coated on at least one of the two faces thereof with a layer (5) of an electrically conductive material, characterised in that the material is selected from CrN and a bivalent or trivalent Ti compound or a mixture of such compounds, in that if the electrically conductive material is a bivalent or trivalent Ti compound or a mixture of such compounds, the layer (5) contains at most a quantity of oxygen in at. %, measured by X-ray photoelectron spectroscopy (XPS) on the upper 10 nm of the layer, which does not exceed 1.5 times the content in at. % of oxygen which, according to the measured content in at. % of Ti, would correspond to a coating which consists entirely of TiO, and in that at least one intermediate layer (4) of a metal or an alloy metal is positioned between the substrate (1) and the layer (5) of electrically conductive material, the thickness of the layer (4) of metal material being at least 1 nm over the entire surface of the substrate (1).

The invention also relates to a method for producing said bipolar plate, a fuel cell unit including same, and a fuel cell including said unit.

The present invention relates to the manufacture of a metal strip or sheet, and the strip or sheet thus produced, which applies more particularly to the manufacture of fuel cell unit elements.

Fuel cells of the PEMFC type, i.e. with a proton exchange membrane, comprise battery units each consisting of an anode/electrolyte/cathode assembly, also called MEA (Membrane Electrode Assembly), gas diffusion layers, also called GDL (Gas Diffusion Layer), extending on either side of the MEA assembly, and bipolar plates. The bipolar plates make the elements of the battery unit form an assembly. They also define fluid circulation channels, distribute gases and coolant, and evacuate the water generated in the cell, which helps to control the humidity of the proton exchange membrane. They also have the function of collecting the current generated at the electrodes.

Given the essential role played by bipolar plates within the fuel cell, as well as the growing importance of such cells in many fields, it is desirable to develop compact bipolar plates, inexpensive to manufacture and providing, in addition, long service life in the fuel cell. Their Interfacial Contact Resistance (ICR) must be as low as possible. An ICR of 10 mΩ·cm² under a contact pressure of 100 N·cm⁻² would represent a maximum which, optimally, should not be exceeded.

Documents WO-A-2016/151356 and WO-A-2016/151358 have proposed a method for manufacturing a metal strip or sheet that is particularly suitable for the manufacture of bipolar plates, comprising the provision of a substrate made of stainless steel and the deposition of a layer based on chromium nitride on the substrate by Physical Vapor Deposition (PVD) in a deposition installation comprising a deposition chamber which may be evacuated and may also be supplied with a mixture of inert gas such as argon and nitrogen. The chamber also comprises a chromium target disposed above the top face (for example) of the substrate, the substrate passing through the deposition chamber in a longitudinal direction. A suitable potential difference is applied between the target and the substrate. The deposition chamber comprises a deposition zone with a length strictly less than the length of the deposition chamber, taken in the longitudinal direction and at least one first “prohibited zone”, adjacent to the deposition zone in the longitudinal direction, wherein, upon deposition, chromium nitride is deposited on the substrate only in the deposition zone. No deposition of chromium nitride occurs on the substrate in the first “prohibited zone”.

The first “prohibited zone” may be located downstream of the target on the path of the substrate.

The rate of deposition of chromium on the substrate may be greater than or equal to a predetermined threshold in the deposition zone, downstream of the target.

Typically, the deposition chamber comprises a downstream screen, impermeable to chromium atoms to prevent the projection of chromium nitride onto the substrate in the first “prohibited zone”, while allowing the projection of chromium nitride onto the substrate in the deposition zone. To this end, the downstream screen is typically interposed on the trajectory of the chromium atoms projected towards the first zone, and is so placed in the deposition chamber to prevent the deposition on the substrate of the chromium atoms issuing from the target for which the deposition rate on the substrate would be strictly less than the predetermined threshold.

The deposition chamber may further comprise a second “prohibited zone” in which there is no deposition of chromium nitride on the substrate during the deposition step, the second “prohibited zone” being adjacent to the deposition zone so that the first “prohibited zone” (downstream zone) and the second “prohibited zone” (upstream zone) surround the deposition zone in the longitudinal direction of travel of the strip or sheet. Typically, the chamber then further comprises, in addition, an upstream screen, impermeable to chromium atoms, said upstream screen being placed in the chamber and interposed on the trajectory of the chromium atoms projected in the direction of the second “prohibited zone” from the target, so as to allow the projection of chromium nitride on the substrate in the deposition zone and to prevent the projection of chromium nitride on the substrate in the second “prohibited zone”.

Throughout the deposition zone, the rate of deposition of chromium atoms on the substrate during deposition is preferably greater than or equal to the predetermined threshold.

The method further comprises, prior to the deposition step, a step of determining the predetermined threshold for a given deposition installation, by calibration, wherein the predetermined threshold corresponds to the minimum deposition rate for which a coating layer is obtained that exhibited the desired contact resistance.

The metal strip or sheet is made of stainless steel, its thickness is typically of the order of 0.1 mm but may be even less, and it initially comprises, on its surface, a passive oxidation layer which is completely eliminated at least in the areas intended to be coated with the coating layer so that, in these areas, no residual passive layer remains at the start of the deposition step.

A deposit on both faces of the strip or sheet is possible if the chamber has two chrome targets arranged on either side of the strip or sheet and separated from one another on the trajectory of the strip or sheet, and the cache(s) associated with each target.

A metal strip or sheet is thus obtained comprising a stainless steel substrate and a coating layer on at least one of its faces, based on chromium nitride, the coating layer optionally comprising oxygen, said coating layer being obtained by Physical Vapor Deposition (PVD). It should be noted that the oxygen possibly present in the coating layer results only from inevitable sealing imperfections of the chamber and from desorption from the walls of the chamber, or even from the substrate. It does not come from a deliberate addition of oxygen to the treatment atmosphere, which aims to obtain a layer comprising a certain proportion of a metal oxide.

The coating layer comprises, on its surface, a surface zone with an atomic oxygen content strictly less than its atomic nitrogen content. Typically, the surface zone has a height less than or equal to 15% of the total thickness of the coating layer.

The coating layer comprises, at the interface with the substrate, an interface zone comprising an atomic oxygen content strictly less than its atomic nitrogen content. Typically, it has a height less than or equal to 15% of the total thickness of the coating layer;

The coating layer may thus have an Interfacial Contact Resistance (ICR) less than 10 mΩ·cm² at 100 N·cm⁻².

The coating layer is formed directly on the stainless steel substrate, without the interposition of a passive layer between the coating layer and the stainless steel of the substrate. The coating layer is textured, and, in particular, has an epitaxial relationship with the stainless steel of the substrate. This epitaxy should remain present after the plate shaping. The differences in mechanical properties between the substrate and the coating cause this condition to be maintained, at the cost of localized breaks in the CrN layer, which are not really troublesome. Where the substrate becomes exposed, the passivation layer is reconstituted and prevents significant corrosion of the plate, especially since the surrounding environment is relatively slightly acid (pH in the order of 4 or 5).

It is thus possible to obtain a bipolar plate for a fuel cell comprising at least one plate obtained by deformation of a sheet, or of a blank cut from a strip as mentioned above.

In the example described in this document, a plate coated with a CrN-based coating layer on only one of its faces is prepared. For this purpose, there is only one PVD target in the chamber, which overhangs the trajectory of the strip or sheet above the face to be coated. In practice, however, there is always a little CrN which is deposited on the opposite face of the strip or sheet moving through the processing chamber, which is not in itself a problem.

Manufacturers of fuel cells, however, desire to have more efficient plates than those just described. On the one hand, CrN is not the best material for constituting the textured coating layer, and there is little margin available to reliably obtain at all points of the plate a contact resistance lower than the prescribed threshold of 10 mΩ·cm² at 100 N·cm⁻².

On the other hand, single-sided coating of the plate is adequate if, to achieve the assembly of the bipolar plates, the plates are welded to each other after their deformation, wherein the welding is carried out on the uncoated faces, because the solder material contributes to the electrical conductivity of the assembly. But if the assembly is carried out by another means, there is a degradation of the contact resistance in the areas where the metal has been exposed during the shaping of the plates by causing the reconstitution of the passivation layer. The quality of the assembly in terms of electrical conductivity is therefore degraded.

Finally, more incidentally, having a strip or a sheet of which the two faces are different by their coatings, or the absence of a coating on one of the faces, wherein it is not always clearly identifiable visually, introduces a possible source of error when assembling the bipolar plate.

The present applicants have also proposed in application PCT/IB2017/056925 to replace the deposit of CrN by a layer of a conductive compound of bivalent Ti (such as TiN and TiO) or trivalent (Ti₂O₃), or of a mixture of such compounds. If this mixture does not contain an excessive amount of nonconductive tetravalent Ti compound such as TiO₂, it is thus possible to obtain a coating layer whose ICR is less than 5 mΩ·cm⁻² at 100 N·cm⁻². Said layer therefore contains at most an amount of oxygen in at. %, measured by X-ray Photoelectron Spectrometry (XPS) over the upper 10 nm of said layer, which does not exceed 1.5 times the content of at. % of oxygen which, according to the content of at. % of measured Ti, would correspond to a coating which would be entirely composed of TiO. At the user's choice, such a coating may be present on both sides of the strip or sheet, or only on one of them, the other side remaining bare or having only a parasitic deposit on its edges of bivalent or trivalent Ti compound(s), or being covered with a deposit of another nature, such as CrN.

However, it has been found that the bipolar plates thus formed do not always perform optimally over a satisfactory period of use. These layers of bivalent or trivalent Ti, and also the CrN layers, tended to crack excessively during the drawing step that gives the membrane its desired shape. This cracking increases the risk of contamination of the proton exchange membrane by Fe, Cr or other ions from the substrate since the latter is found bare in the areas where the coating is cracked through its entire thickness.

The aim of the invention is to provide a metal strip or sheet constituting a bipolar plate for a fuel cell element, having, on at least one of its faces, a deposit consisting essentially of at least one compound of bivalent or trivalent Ti, or of CrN, and which make it possible to manufacture fuel cell units having a useful life under satisfactory optimum conditions.

To this end, the invention relates to a bipolar plate for assembling the elements of a fuel cell unit, consisting of a stainless steel substrate coated on at least one of its two faces with a layer of ‘an electrically conductive material, characterized in that said material is selected from among CrN and a bivalent or trivalent Ti compound or a mixture of such compounds, in that if said electrically conductive material is a compound of bivalent or trivalent Ti or a mixture of such compounds, said layer contains at most an amount of oxygen in at. %, measured by X-ray Photoelectron Spectrometry (XPS) on the upper 10 nm of said layer, which does not exceed 1.5 times the at. % oxygen content which, according to the measured at. % of Ti content, would correspond to a coating which would be entirely composed of TiO, and in that between said substrate and said layer of electrically conductive material is interposed at least one interlayer layer of a metal or a metal alloy, the thickness of said layer of metallic material being at least 1 nm, preferably at least 5 nm, more preferably at least 15 nm, over the entire surface of the substrate.

Said metal or metal alloy may be chosen from Ti, Al, Cr, alloys based on Ti or Al or Cr, a stainless steel.

The ductility of at least one layer of a metal or metal alloy may be intermediate between that of the substrate and that of the layer of a bivalent Ti compound or mixture of compounds.

The bipolar plate may comprise several superimposed intermediate layers, and the respective ductilities of said superimposed layers may create a ductility gradient within the layers, the respective ductilities of said superimposed intermediate layers gradually approaching that of the layer of conductive material.

Said Ti compound, if it is bivalent, may be chosen from TiN, TiO and mixtures thereof.

The two faces of said plate may each be coated with a layer of at least one bivalent or trivalent Ti compound, each of said layers containing at most an amount of oxygen, measured by X-ray Photoelectron Spectrometry (XPS) over the upper 10 nm of said layer, which does not exceed 1.5 times the at. % of oxygen content which, according to the measured at. % of Ti content, would correspond to a coating which would be entirely composed of TiO.

The conductive layer of one of the faces of the plate may be a bivalent or trivalent Ti compound or a mixture of such compounds, containing at most an amount of oxygen, measured by X-ray Photoelectron Spectrometry (XPS) over the upper 10 nm of said layer, which does not exceed 1.5 times the at. % of oxygen content which, according to the measured at. % of Ti content, would correspond to a coating which would be entirely composed of TiO, while the conductive layer of the other side may then be CrN.

The object of the invention is also a method for manufacturing a bipolar plate for assembling the elements of a fuel cell unit, consisting of a stainless steel substrate coated on at least one of its two faces with an electrically conductive material, characterized in that said material is chosen from CrN and a bivalent or trivalent Ti compound or a mixture of such compounds, wherein that said layer, if it consists of a bivalent or trivalent Ti compound or a mixture of such compounds, contains at most an amount of oxygen, measured by X-ray Photoelectron Spectrometry (XPS) on the upper 10 nm of said layer, which does not exceed 1.5 times the at. % oxygen content which, according to the measured at. % Ti content, would correspond to a coating which would be entirely composed of TiO, and wherein:
a stainless steel substrate is provided in the form of a strip or sheet;
at least one of the surfaces of the substrate is deposited on at least one layer of a metal or a metal alloy;
there is deposited on at least said face of the plate a layer (5) of a compound or a mixture of compounds of bivalent Ti by Physical Vapor Deposition (PVD) in a deposition installation comprising at least one deposition chamber, means for causing the substrate to scroll inside said chamber in a longitudinal direction, means for limiting or controlling the quantity of air and oxygen introduced into the chamber, and at least one Ti target;
said substrate thus coated is cut and shaped to give it the desired shape and dimensions so as to obtain a bipolar plate for a fuel cell.

Said metal or metal alloy may be chosen from among Ti, Al, Cr, alloys based on Ti or Al or Cr, a stainless steel.

The ductility of at least one layer of a metal or metal alloy may be intermediate between that of the substrate and that of the layer of a bivalent Ti compound or mixture of compounds.

Several superimposed intermediate layers may be deposited, the respective ductilities of said superimposed intermediate layers creating a ductility gradient within the layers, the respective ductilities of the intermediate layers progressively approaching that of the layer of conductive material.

Said Ti compound, if divalent, may be selected from among TiN, TiO and mixtures thereof.

One face of the substrate may be coated with a conductive material consisting of a bivalent or trivalent Ti compound or a mixture of such compounds, while the other face may be coated with a conductive material consisting of CrN.

Another object of the invention is a unit for a PEMFC type fuel cell, composed of an anode/electrolyte/cathode assembly, the anode and the cathode comprising at least one bipolar plate comprising a stainless steel substrate coated on at least one of its faces by an electrically conductive material, characterized in that at least either the anode or the cathode comprises at least one bipolar plate of the preceding type.

The invention also relates to a fuel cell comprising units of bipolar plates for assembling the elements of its units, characterized in that at least one of said units is a unit of the preceding type.

As it has been understood, the invention is based on the presence, between the stainless steel substrate and the coating of bivalent and/or trivalent Ti compound(s), of an intermediate layer of metallic Ti, of a metal such as Cr and Al, or, more generally, a metal or a metal alloy which exhibits deformation properties similar to those of stainless steel due to the proximity of their ductilities.

The inventors have found that if the bipolar plates formed, according to the prior art, by a stainless steel substrate coated with a conductive layer of TiN and/or TiO and/or Ti₂O₃ (or of bivalent or trivalent Ti compound generally) did not always perform optimally over a satisfactory period of use, this was due to the fact that these conductive layers tended to crack excessively during drawing intended to give the membrane its desired shape. This cracking, when it is pronounced to the point of affecting, in places, the entire thickness of the conductive layer, increases the risk of contamination of the proton exchange membrane by Fe, Cr or other ions released by the substrate since it is found to be bare in the cracked areas through the entire thickness of the coating.

Drawing, if it results in a very appreciable change in the shape of the coated sheet, introduces mechanical stresses into the coatings which tend to crack them, or even endanger their adhesion to the substrate, and shorten the period of use under good conditions of the fuel cell in which the element containing the defective membrane is integrated.

The inventors therefore imagined carrying out, prior to the deposition of the layer of Ti or CrN compound(s), the deposition, by any method, of at least one ductile metal layer, said layer (or the lower layer if there are several) providing good adhesion to the stainless steel substrate. It is therefore on this metallic layer or this set of metallic layers that the deposition of either CrN or of Ti compound(s) takes place according to the procedures set out in application PCT/IB2017/056925 and that we will mention here in detail.

Metallic Ti, for example, has the advantage of being deformed, during drawing, in a manner very comparable to that of the stainless steel substrate, in any case significantly better than does the conductive layer of non-metallic compound(s) of bivalent or trivalent Ti which determines the ICR of the fuel cell membrane which is the preferred application of this type of material. From this point of view, the ductility of the metal layer relative to that of the substrate is one of the main criteria to be respected, as well as its adhesion both to the substrate and to the conductive layer of bivalent or trivalent Ti which will then be deposited.

The ductility of a deposited metallic material may be represented by its elongation at break. The elongation at break property of the sublayer(s) present between the stainless steel substrate and the surface conductive layer is preferably chosen such that the elongation at break of each layer is intermediate between the elongation at break of the layer on which it is deposited (or the elongation at break of the substrate in the case of the first metallic layer deposited) and that of the layer which is deposited on it (or of the conductive layer in the case of the last metal layer deposited). Experience will be able to confirm that the materials chosen (in particular in the case where several are deposited successively, in particular to create a ductility gradient in the deposit) are indeed suitable, taking into account the thickness of the coating and the deformations that it undergoes during a given shaping.

That said, any layer of metal or of any metallic alloy will in any case have a ductility sufficiently close to that of the stainless steel substrate so that its deposition already constitutes progress in the resolution of the cited problems, compared with the case where the conductive layer of CrN or of bivalent or trivalent Ti compound(s) would be deposited directly on the substrate. The presence of several intermediate metal layers of different types and preferably exhibiting a ductility gradient, is only one variant of the invention.

We may also imagine the case of an alternation of ductile metal (or metal alloy) layers and conductive layers, the layer in contact with the substrate being a metal (or ductile metal alloy) layer, and the outermost layer of the coated sheet being a conductive layer.

The invention will be better understood upon reading the following description, given with reference to the following appended figures:

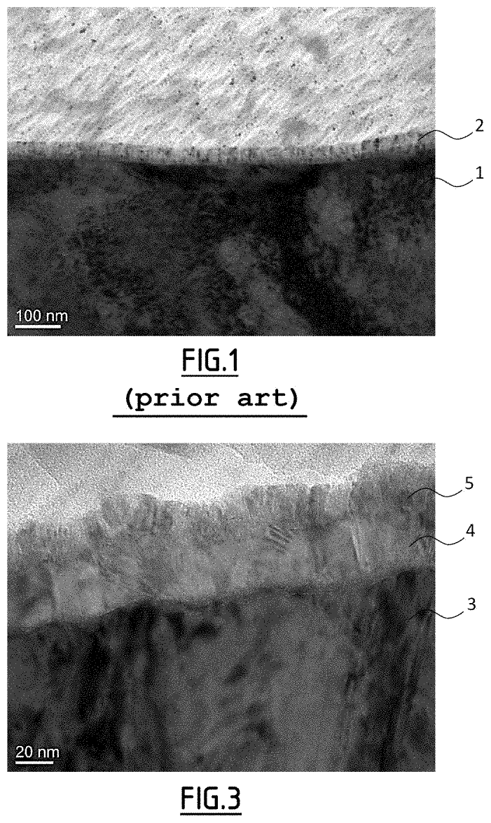

FIG. 1 shows a cross-section micrograph of the upper surface of a bipolar plate according to the prior art, where a stainless steel substrate is coated with a double layer of TiN;

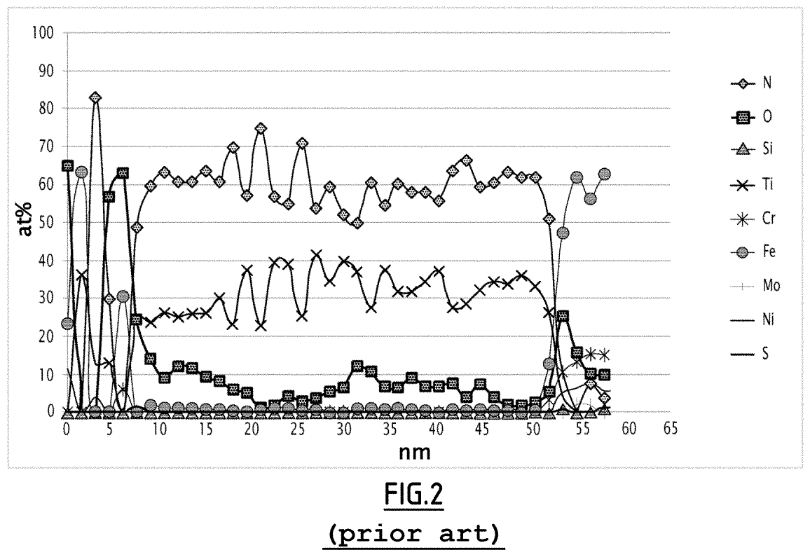

FIG. 2 shows the analysis of the surface area of this bipolar plate according to the prior art, carried out by Energy Dispersive X-ray (EDX), the distance from the surface of the plate being expressed in nanometers (abscissa);

FIG. 3 shows a cross-section micrograph of the upper surface of a bipolar plate according to the invention, where a stainless steel substrate is successively coated with a layer of metallic Ti and a layer of TiN;

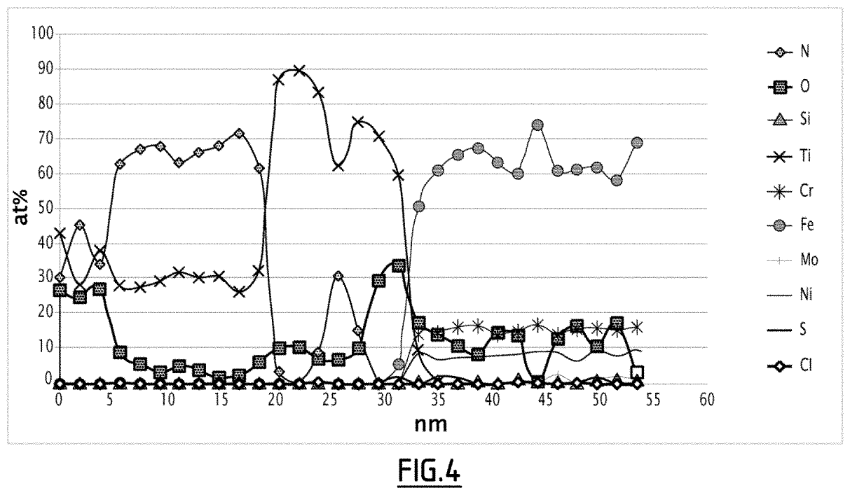

FIG. 4 shows the analysis of the surface area of this bipolar plate according to the invention, performed by Energy Dispersive X-Ray (EDX), the distance from the surface of the plate being expressed in nanometers (abscissa);

FIG. 5 shows the upper surface of the bipolar plate of FIG. 3 after deformation by drawing;

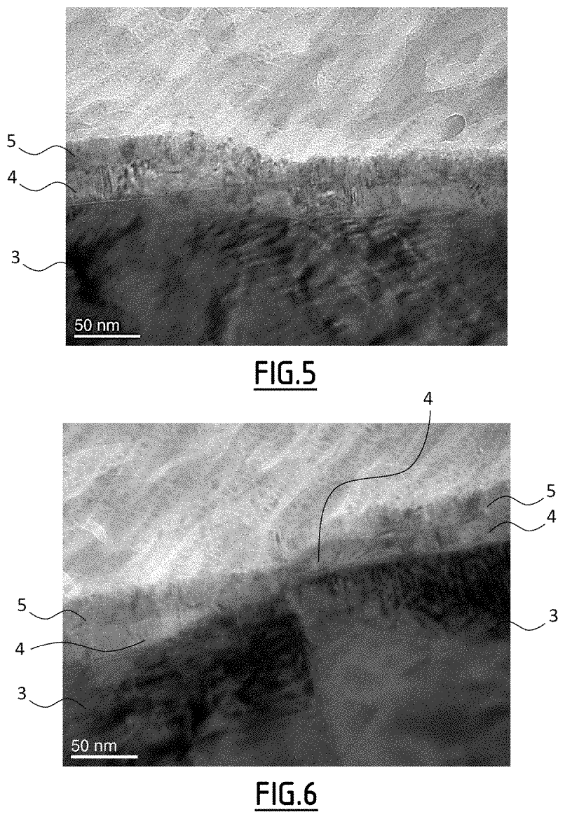

FIG. 6 shows the upper surface of the bipolar plate of FIG. 3 after deformation by drawing greater than that undergone in the case of FIG. 5.

In the remainder of the description, we will focus on the case where the substrate is a stainless steel of known type SUS 316L, where the intermediate coating is substantially pure Ti (i.e. without alloying elements deliberately added) and where the conductive coating determining the ICR is TiN, the other components possibly present in a relatively marginal way in the coating (for example various oxides of bi, tri or tetravalent Ti) having been formed only involuntarily.

FIG. 1 shows for reference a micrograph of a section according to the thickness of substrate 1, which is a classic SUS 316L grade austenitic stainless steel. In the example shown, it was covered by PVD with a double layer 2, composed essentially of TiN with a thickness of approximately 45 nm. But a single layer of TiN would be equally suitable. The growth of TiN 2 occurs in a columnar manner from substrate 1.

FIG. 2 shows the analytical spectrum produced by the process known as Energy Dispersive X-ray (EDX) and which makes it possible to see, on the ordinate, the respective at. % contents of the various elements mentioned in the diagram and their evolution from the surface of a deposit 2 of TiN (zero abscissa) to a depth of approximately 60 nm, carried out on another sample and a little thicker than the deposit shown in FIG. 1. It may be seen that the extreme surface has a high content of both Ti and O, because the Ti has absorbed residual oxygen in this extreme surface. The presence of Fe and Cr at the extreme surface indicated by this diagram is, in fact, only an aberration of analysis. The analyzes by XPS do not actually confirm this presence. But very quickly, from about 5 nm deep from deposit 2, the nominal composition of deposit 2 is established, with essentially TiN and a marginal presence of oxygen. From a depth of around 50.5 nm, the Fe and Cr contents of the deposit increase, indicating that the TiN deposit 2 and the steel of substrate 1 begin to interpenetrate. From approximately 55 nm, we are on the stainless steel substrate 1 as shown by the very predominant presence of Fe, Cr, Ni, mixed with the oxygen which is integrated into the passive layer, the spontaneous formation of which is usual in the extreme surface area of stainless steels and which gives them their resistance to corrosion. This oxidized passive layer on the extreme surface of the stainless steel 1 is, however, not favorable to the adhesion of TiN (or other non-metallic coatings based on bivalent or trivalent Ti, which may be used in the invention, alone or mixed). It is therefore desirable, in this reference configuration, to remove it as much as possible before depositing the conductive layer 2 on the substrate 1.

It should be noted that we have reproduced in FIG. 2 (as in FIG. 4 which will be commented later) a result of analysis by EDX and not by XPS, whereas it is the analysis by XPS which serves as a reference to determine, under the conditions which have been mentioned, whether the TiN deposit would not contain an excessive quantity of oxygen which would place it outside the conditions required by the invention. This is because an analysis by EDX makes it possible to examine the sample at a sufficient depth to obtain an analysis of the whole of the conductive deposit, of the intermediate metallic layer according to the invention, and of the first edge of the stainless steel substrate. An XPS analysis would allow only the top 10 nm of the conductive layer 2 to be considered. But it allows them to be analyzed with sufficient precision to determine whether this conductive layer does indeed comply with the requirements of the invention with respect to the ratio between the contents in at. % of O and Ti, while the EDX is not quantitative enough for this purpose.

In general, the conductive layer present on the surface of the bipolar plates according to the invention may have the characteristics described in documents WO-A-2016/151356, WO-A-2016/151358 or PCT/IB2017/056925).

In a preferred example, this layer is formed predominantly of compounds of bivalent or trivalent titanium, in particular TiN and/or TiO, deposited by PVD, on one or, preferably, on both faces of the strip or sheet.

TiN, for example, would indeed be a more suitable material than the CrN used, in particular, in WO-A-2016/151356 and WO-A-2016/151358, because it is suitable for obtaining ICR less than 5 mΩ·cm² at 100 N·cm⁻². The ICR of TiO is of the same order of magnitude as that of TiN.

In general, to form layer 2, the strip or sheet is coated with a material essentially based on divalent or trivalent Ti, which is for example, in particular, TiN, TiO or a mixture of these two compounds of bivalent Ti. It turns out, in view of the experiments carried out by the inventors, that it is the bivalent or trivalent nature of the Ti compounds deposited on the strip or the sheet which is fundamental for the performance of the bipolar plate, and that TiN, TiO and their mixtures are quite substantially equally adequate to provide low contact resistance, typically less than 5 mΩ·cm² at 100 N·cm⁻². Also suitable are trivalent Ti conductive compounds such as Ti₂O₃.

The very significant presence of insulating compounds of tetravalent titanium such as TiO₂ is, on the contrary, to be avoided in this coating, at least on the first 10 nm of its upper layer which are the most important to ensuring that the strip or the sheet have a suitable contact resistance.

In general, the coating based on bivalent or trivalent Ti must have, on this surface thickness of 10 nm, an overall content in at. % of oxygen (i.e. expressed in atomic percentages) which must not exceed by more than half (in other words not greater than 1.5 times) the oxygen content measured in at. % which, in view of the measured Ti content, also in at. %, would correspond to a coating which would be integrally formed of TiO, on the basis of an analysis of the coating carried out by the so-called X-ray Photoelectron Spectroscopy (XPS) method.

In practice, it is sufficient to carry out this analysis on the top 10 nm of the coating layer, since the O content of the coating and the formation of tetravalent Ti which may result from it, is highest at its extreme surface, this zone having been, during the deposition operation, the furthest from the Ti target. This thickness of 10 nm also corresponds to the conventional resolution of the XPS method.

Of course, ideally, it would be desirable to be able, during the deposit analysis, to discriminate between the divalent or trivalent (desired) and tetravalent (unwanted) Ti compounds. However, the various conventional analysis methods do not make it possible, or not sufficiently precisely, to carry out this discrimination which would make it possible, for example, to set an admissible TiO₂ content in the coating so that the contact resistance would be sufficiently low. This content of admissible tetravalent Ti compounds is therefore understood indirectly by the measurement and calculation which have been cited, on the basis of the atomic percentages of Ti and O.

The document “Thin layers of titanium oxynitride: reactivity as an original means of physico-chemical characterization” by J. Guillot, thesis of the University of Burgundy, 2002, provides information on the methods of analysis of this type of deposit.

The invention will be better understood from the following description.

TiN is a high-performance material in terms of contact resistance. It turned out that the method of depositing CrN by PVD, carried out under conditions comparable to those set out in the documents of the prior art cited in the introduction, was also suitable for depositing TiN. It is however necessary that the surface of the metal support is cleaned very well before the deposition of TiN, and it is advisable to clean it by a conventional process of chemical pickling adapted to the material used. For stainless steel, use will therefore preferably be made of an argon plasma pickling.

Another difficulty encountered by those skilled in the art is that when a nitride deposition by PVD is carried out on only one of the faces of the strip or sheet moving by the preceding method, it is observed that the other face, and, in particular, its edges, is also fatally influenced by the operation, and that a deposit of nitride also takes place there, in a marginal but not entirely negligible way, and under conditions that make precise composition of the deposit as well as the main deposit, uncontrollable, in particular in the presence of the oxygenated phases.

This phenomenon is not very annoying when one aims to obtain a single-sided deposit. On the other hand, when it is desired to obtain a deposit on both faces of the strip or sheet by arranging targets in Cr or Ti, for example, on either side of the strip or sheet, with one arranged in the upstream part of the chamber and the other in the downstream part of the chamber, the coating deposition in the downstream part may be accompanied by a parasitic coating deposit on the face which had already been coated in the upstream part of the chamber and which is thus liable to degrade its properties. This is particularly the case when the atmosphere of the chamber is not as poor in oxygen as it should optimally be so as to form only TiN, because of leaks, in particular, at the inlet and from the outlet of the strip or sheet, or of oxygen or water adsorbed on the walls of the chamber and not sufficiently evacuated before the execution of the coating, or of oxygen or water provided by the strip or sheet. If, as will be seen, the formation of TiO₂ may be accepted or even desired, it is still necessary that this formation is well mastered so that TiO₂ is not obtained in too large a quantity. Good control of the presence of oxygen or water vapor in the chamber is anyway necessary in this case, and the entry of air or parasitic water vapor must be avoided.

In the case of a bi-layer deposit of TiN according to the invention, however, the problem of parasitic deposits on the other face of the strip or sheet than that concerned by one of the two Ti targets does not arise, or much less than for a single-sided deposit where only one target is used.

In fact, the fact of having conductive coatings of different compositions but of substantially equivalent electrical conductivities (TiO and TiN for example) on the two faces of the strip or sheet has the consequence that the material which could be deposited in an uncontrolled manner on the face other than the one that a given target is supposed to treat, does not modify the contact resistance property of the material which is actually to be deposited thereon. The conductivity of the surface of the layer deposited on the first face of the strip or sheet is therefore not, a priori, altered by a parasitic deposit resulting from the deposition of a layer deposited in an uncontrolled manner on the second face of the strip or sheet.

Also, having both faces coated with the same material provides reversibility for the strip or sheet. It is therefore not necessary for the operators or the manufacturing devices of the fuel cell units to be able to distinguish, visually or otherwise, between the two faces of the strip or sheet which must be turned towards the electrolyte after assembly of the MEA concerned.

Optimally, in the case where the strip or sheet is coated on both faces with a layer composed of bivalent and/or trivalent Ti, it is preferred, but not mandatory, to place two targets in Ti on either face of the strip or sheet, substantially opposite to one another and at equal distances from the strip or sheet. The screens defining the prohibited zones and the permitted zones for the deposition of the layers on each face are also arranged symmetrically with respect to the strip or sheet. In this way, the two faces are coated substantially at the same time and using the same parameters. If parasitic deposits do occur, they occur in a very comparable manner on the two faces, which minimizes their influence on the final properties of the coated material, the two faces of which are thus coated in substantially identical ways.

In the case of TiN, a reaction of Ti with the oxygen present in the chamber results in the formation of Ti oxides of various valences, namely TiO and/or Ti₂O₃ and/or TiO₂. The formation of TiO₂ in large quantities is to be avoided because it is an insulating phase. On the other hand, TiO is a conductive phase in the same way as TiN, and its presence within the TiN layer, or on its surface, or at the substrate/TiN interface does not lead to deterioration of the contact resistance. TiO may even be the exclusive or almost exclusive constituent of the conductive phase, the essence of which is that it consists of bivalent conductive Ti compounds (TiN, TiO), as opposed to non-conductive tetravalent Ti compounds, such as pure TiO₂, which are to be avoided. Trivalent Ti compounds such as Ti₂O₃ are also suitable. As has been said, the criterion to be taken into account is that the coating based on bivalent or trivalent Ti must comprise, over a surface thickness of 10 nm, an overall at. % oxygen content that must not be greater than 1.5 times the oxygen content measured in at. % which, in view of the measured Ti content, also in at. %, would correspond to a coating which would be entirely formed of TiO, on the basis of an analysis of the coating performed by XPS.

If a majority TiN formation is sought, it is preferable to take the same precautions as in the deposition methods described above in order to limit as much as possible the entry of parasitic air. The thermodynamics and the kinetics of the formation of Ti oxides mean that TiO is formed in a privileged way, and that TiO₂, which is to be avoided, only forms significantly if the quantity of oxygen available is sufficient for this purpose, in relation with the temperature at which the deposition takes place.

When we want to deposit CrN, the Cr oxides that may form are not conductive and are anyway harmful to the conductivity of the deposit, and therefore to the contact resistance. Their significant formation should be avoided as much as possible, again taking care to limit the introduction of oxygen and humidity into the chamber. Documents WO-A-2016/151356 and WO-A-2016/151358 give examples of quantitative indications on the compositions of layers containing Cr, N and O which would be suitable.

Another advantage of a two-sided deposition (whether the two layers are of the same nature or not) is that the manufacturer of the fuel cell units may minimize or eliminate the step of welding the microchannels together.

The analysis of the deposit may be carried out by any suitable method which would give a direct or indirect indication of the chemical nature of the deposit and of the excessive presence of tetravalent Ti in the form of pure TiO₂. As has been said, X-ray Photoelectron Spectrometry (XPS) is a particularly suitable method since, although it cannot give a clear quantitative indication of the presence of the different possible phases (TiN, TiO, Ti(NO), Ti₂O₃, TiO₂ etc.), it nevertheless makes it possible to deduce, by comparison between the respective atomic contents of Ti and O measured at the surface of the coating to a depth of approximately 10 nm, whether the probability of an excessive presence of tetravalent Ti in the entire coating is too high for the coated strip to be considered suitable for constituting a bipolar plate according to the invention. From this point of view, as we have said, the analysis of the first 10 nm of the external surface of the layer is sufficient to allow determining whether or not the coating would have the necessary qualities, as, on the one hand, these first 10 nm are the most important for obtaining good contact resistance, while, on the other hand, they are the part for which the pollution by oxygen leading to excessive oxidation of Ti would be maximum.

From routine experiments, it will then be easy for the operator to determine which settings of the installation at his disposal allow an adequate composition of the TiN or TiO layers, or mixtures of these two compounds, to be achieved. (or, in general, bivalent or trivalent Ti conductive compounds), and to prevent TiO₂ (or other tetravalent and non-bivalent or trivalent Ti compounds) from being present in excessive amounts. To obtain a sufficiently low quantity of TiO₂ in the coating, it is necessary to have the chamber where the deposition takes place under reduced pressure for a sufficient time so that the air and the water vapor initially present therein are removed in sufficient quantities. It is also necessary, during the presence of the strip or of the sheet in this chamber, that the air inlets are minimized so that the deposition atmosphere is well controlled. In practice, a pressure of 10⁻⁴ mbar or less, when no neutral gas and/or nitrogen is added, is a sign that this atmosphere will not be sufficiently oxidizing for excessive formation of TiO₂ to be probable. Tests carried out on the deposit installation at their disposal will enable those skilled in the art to determine exactly what precautions are necessary, in particular in terms of the chamber being sealed against parasitic air inlets, so that the objective is achieved. It is also necessary, as we said, sometimes to take into account the oxygen and the water which are introduced into the chamber by the product to be coated itself because they are adsorbed on its surface. It may be preferable, from this point of view, that the Ti target(s) are not located too close to the entrance of the strip moving into the chamber, so that the adsorbed oxygen and water have sufficient time to be evacuated by the pumping installation before the portion of the strip from which they would be obtained reaches the zone of formation of the TiN/TiO coating, possibly also containing trivalent Ti compounds such as Ti₂O₃.

If one accepts or seeks a significant formation, even as exclusive as possible, of TiO instead of TiN as the compound of bivalent Ti, the reactive gas may be a nitrogen/oxygen mixture whose composition and flow rate may be adjusted by those skilled in the art to the sputtering power and the geometry of their installation, to avoid finding tetravalent titanium on the surface of its deposit as described above.

It goes without saying that in addition to the elements that have been mentioned, the installation includes everything that is necessary and customary for the production of a PVD coating deposition on a moving substrate in a controlled atmosphere chamber, such as means for moving the substrate inside the chamber in a longitudinal direction if the substrate is a moving strip, means imposing a suitable electrical potential difference between the targets and the substrate, etc.

The mechanical properties of TiN and TiO are not fundamentally different from those of CrN, so that they do not react more adversely than CrN to the cutting and shaping of the strips or sheets for the production of the plates. They also develop from the surface of the substrate with remarkable epitaxy, forming columns in line with the grains of the substrate. This epitaxy may be observed on X-ray diffraction examinations in area selection through transmission electron microscopy: there is a very good coincidence of the diffraction spots due to TiN and TiO with those due to the grains of the substrate.

The deposition of TiN, TiO, their mixtures or any other bivalent or trivalent conductive Ti compounds that would be formed by adapting the atmosphere and the treatment pressure as those skilled in the art know how to do, according to the invention, may be carried out simultaneously on both faces of the substrate, if the Ti targets face each other in the chamber by being located on either side of the substrate. When the substrate is a moving strip, the deposition may also take place successively on both faces of the strip if the two targets are offset from one another. Placing the two Ti targets face to face on either side of the strip has, however, the advantage of making the deposition-making facility more compact than if the targets were offset. Also, as has been said, this makes it possible to reduce the disadvantages caused by parasitic deposits of TiN or TiO and other compounds on the other face than that specifically targeted by a given target.

As for the deposition of CrN described in the aforementioned prior art, it is possible to use screens delimiting the deposition zones of the Ti compounds and “prohibited zones” in order to suppress as much as possible the introduction of oxygen into the layer of Ti compounds according to the invention. However, one of the advantages of using Ti instead of Cr is, as has been said, that the presence of oxygen in the deposit as TiO is not really detrimental to the contact resistance of the deposit. Under these conditions, actively limiting this presence of oxygen other than by normal sealing of the inlet and the outlet of the chamber may very well not be necessary, and one can avoid the use of screens impermeable to atoms resulting from one of the targets which, in the case of a deposit of CrN whose O content had to be carefully controlled in its relation to the Cr and N contents, was useful for delimiting prohibited zones.

If it turns out that the presence, within certain limits, or even mainly, of TiO and/or Ti₂O₃ (but not TiO₂) in the deposit presented advantages, we may even consider controlling this presence also by measuring and controlling the amount of oxygen present in the chamber. This control may be achieved by varying the tightness of the chamber relative to the external environment, in particular at the level of the entry and exit of the substrate, and/or by introducing a controlled quantity of oxygen into the nitrogen that is blown into the chamber.

Simple experiments allow those skilled in the art to determine whether the use of screens defining “prohibited zones”, under given operating conditions, would be really useful for obtaining sufficient properties for the deposition of Ti compounds and for regulating its deposit rate, which is one of the factors on which depends the ratio between Ti, N and O inside the coating.

If there is an interest therein, the two faces of the sheet or strip may be coated with two different materials based on bivalent Ti, which would both meet the requirements of the invention (for example one face has a coating essentially composed of TiN while the other face has a coating essentially composed of TiO, or both faces are coated with a TiN—TiO mixture but in different proportions on each face . . . ). To do this, we may:
Either use a coating installation which only treats one side of the substrate at a time, and effect two consecutive passes of the substrate in said installation, after having turned the substrate over and modified the installation settings (for example, the composition of the treatment atmosphere) so that, for example, the coating on one face is essentially TiN while the coating on the other face is essentially TiO;
Or use an installation comprising two very distinct coating zones, one treating the first face of the substrate, the other treating the second face of the substrate, by adjusting the operating parameters of the two zones in different ways to obtain the respective compositions desired on each face of the substrate.

Another variant consists in coating one face of the substrate with a coating based on bivalent Ti compounds (typically TiN, TiO or their mixtures) or trivalent Ti compounds and in coating the other face with CrN as is known, for example from the approach described in documents WO-A-2016/151356 and WO-A-2016/151358. To this end, the two deposits are made in different chambers. It is obviously preferable that, in this case, the two chambers are connected to each other (with sufficient sealing between them so that their atmospheres do not influence each other too much) and that the substrate (moving or not) is not exposed to the open air during its transfer, which could lead to pollution of its surfaces which would disturb the deposition process in the second chamber. Here again, screens may be used in each chamber to limit the risk of parasitic deposits on the face of the substrate which should not be affected.

Of course, in this case, if the differences in the composition of the coating on each face do not lead to obvious differences in visual appearance, it is very preferable that the two faces are made identifiable in some way by the operator, for the correct assembly of the fuel cell membrane.

The use of TiN, TiO, Ti₂O₃ or their mixtures is not frankly more expensive than that of CrN for the manufacture of bipolar plates. An alternative solution would be the production by PVD of a gold deposit, which would have excellent contact resistance and would allow particularly remarkable epitaxy during the growth of the deposit on the substrate. But industrially, this solution would have the drawback of a cost which would be too dependent on fluctuations in the price of gold, and would obviously require special surveillance during the transport and storage of the raw material, which could be difficult to reconcile with industrial scale use.

After the bifacial deposition of TiN, TiO or any conductive compound of divalent or trivalent Ti, the strip or sheet is conditioned as it is usual so as to obtain a bipolar plate with a shape and dimensions adapted to the intended use, by cutting and shaping, using conventional methods for this purpose through cold deformation, in particular by drawing.

This type of coating is applicable to the coating of any stainless steel known to be suitable for use as a substrate for bipolar plates, in particular because of the mechanical properties governing its ability to be suitably shaped. Mention may be made, without limitation, of stainless steel 1.4404 (AISI 316L), 1.4306 (AISI 304L), 1.4510 (AISI 409) or 1.4509 (AISI 441), therefore both austenitic stainless steels and ferritic stainless steels.

Typically, the grain size of the substrate is less than 50 μm, preferably between 10 and 30 μm.

However, as has been said, these deposits of CrN, TiN, TiO, Ti₂O₃ and their mixtures have the disadvantage of having a high hardness, and therefore a lower ductility than that of the stainless steel substrate on which they are deposited. It will also be noted in FIGS. 2 (prior art) and 4 (invention) a fairly strong presence of O at the extreme surface of the deposit, and also at the interface between the TiN and the substrate and on the surface area of the substrate. This corresponds, for the case according to the invention, to absorption by the Ti of residual oxygen present in the deposition chamber, and to a slight persistence of the passivation layer on the surface of the stainless steel substrate after pickling. For the example according to the prior art, the O of the passive layer was left deliberately and it was not absorbed by TiN as the Ti of the TiN layer is saturated. It is therefore to be expected that the TiN layer will poorly adhere to the substrate.

Thus, when this substrate is subject to deformation, for example by drawing, to give the bipolar plate, coated on one or both faces as its desired final shape, the coating may crack and the top conductive layer may lose its effectiveness.

According to the invention, one or two faces of the stainless steel substrate is/are therefore first coated with a metal or a metal alloy, before carrying out on said face(s) the conductive deposit of CrN or of a bivalent or trivalent Ti compound (TiN, TiO, Ti₂O₃, typically). This metallic deposit preferably has a ductility intermediate between that of the stainless steel substrate and that of the future upper conductive layer to limit the stress concentrations in the coating during drawing. Typically this deposition is carried out by a PVD method using at least one target of the material to be deposited, therefore identical or comparable to the method for depositing the upper conductive layer. This intermediate metallic deposit makes it possible to “dampen” the deformations of the upper conductive layer compared to those undergone by the substrate, and thus to limit the risks of excessive cracking of the conductive layer. This intermediate metallic deposit must also have good adhesion with, on the one hand, the stainless steel substrate and, on the other hand, with the conductive surface of the layer.

Among the metals and alloys to be deposited to form this intermediate layer, stainless steels, Ti, Cr, Al and alloys based on these metals are privileged examples (but not exclusive) as it has been shown that they do not age too significantly during use of the membrane. Their significant avidity for oxygen, in particular, means that they are immediately saturated with oxygen during their deposition process, and their composition does not change over time, while their mode of crystallization prevents oxygen from passing through the network and possibly altering the surface of the substrate by degrading the conductivity at the interface and the adhesion of the metal layer. The adhesions of CrN, and TiN, TiO, TiO₂ and their mixtures on these metals and alloys are also adequate for demanding membrane shaping conditions.

One may, of course, consider using other metals and alloys than those explicitly mentioned. Experience will readily show whether their adhesions to the stainless steel substrate and to the top conductive layer are sufficient for a given deformation of the substrate. Adhesions less favorable than those of the aforementioned metals and alloys may, however, be acceptable when the coated substrate must not undergo shaping that is too complex for its use as a bipolar plate.

A very small thickness of metal layer is sufficient. For example, a 13 nm thick metallic Ti layer deposited on a 0.1 mm or 0.075 mm thick stainless steel sheet is typical.

It is considered that the first atoms of the metallic deposit as an underlayer according to the invention provide an improvement in the deformability of the coating of the stainless steel substrate, compared to a solution where this coating would consist only of the conductive layer of CrN or of divalent or trivalent Ti compound(s). This immediate improvement is linked to the improvement of the adhesion on the areas of the substrate where residues of passive layer could remain. This improvement in adhesion on a substrate which is not completely rid of its passive layer increases until the formation of a covering sub-layer. Then, beyond the minimum thickness guaranteeing complete coverage of the substrate, the ductility gradient phenomenon takes precedence. Those skilled in the art will determine the optimal thickness of the underlayer necessary for the shaping of the channels of the membrane as a function of each target bipolar plate geometry.

However, it is considered that a minimum thickness of 1 nm, preferably at least 5 nm, better still at least 15 nm over the entire surface of the substrate, for the metal layer, is necessary for the phenomenon of a ductility gradient between the substrate and the conductive layer to take precedence. The lowest acceptable thicknesses according to the invention correspond to cases where the plate is not intended to undergo very intense local deformations.

No strict maximum technical limit is set for this thickness of the metal layer, and an optimum thickness for each case, in terms of manufacturing cost and physical properties during the deformation of the plate and its use, may be determined by those skilled in the art using routine experiments. This determination will be made according to the precise characteristics required for the bipolar plate and the fuel cell unit to which it is intended to be integrated. It is considered, however, that it is not economically profitable to deposit a metal layer more than 250 nm thick.

FIG. 3 shows a micrograph of the surface of a sheet 3 of SUS 316L stainless steel coated by PVD, according to the invention, with a layer 4 of metallic Ti whose thickness is, in the present case, substantially uniform and about 20 nm thick. It is therefore on this layer of Ti that, according to a variant of the invention, a layer 5 of TiN was then deposited. The epitaxy of the growth of the Ti layer 4 from the substrate 3 is good, and one also notice the columnar structure of the TiN deposit 5 which is one of the causes of its relative fragility during deformations when it adheres directly to the substrate. The monodomain growth of the Ti layer should also be noted as it develops along the orientation of the stainless steel substrate. It therefore perfectly follows the deformation of the substrate, and makes it possible to attenuate the stress exerted on the columnar layer of TiN during deformation of the plate.

The analysis in at. % of the surface area (the first 6 nm) of the sheet 3 thus coated is shown in FIG. 4, according to the same methods as the analysis in FIG. 2 representative of the reference example of the FIG. 1. It may be seen that over the first 20 nm of the surface approximately, there is a deposit of TiN containing, at the extreme surface, a little oxygen which was found in a residual manner in the deposition chamber and which was captured by the Ti. Then over the next 15 nm or so, there is the deposit of Ti produced according to the invention, which also captured a little residual oxygen from the deposition atmosphere. Some Cr has also migrated into this layer from the substrate. Finally, from a depth of about 35 nm, there is the austenitic stainless steel substrate where Fe, Cr and Ni are predominant.

FIGS. 5 and 6 show in the same way as FIG. 3 the surface of a sheet 3 coated according to the invention, after it has undergone a deformation by drawing in the area shown. We see that in the case of FIG. 5, the deformations of the layers 4 of Ti and 5 of TiN follow very well the deformations of the sheet 3. This is less true in the case of FIG. 6 where the deformation is more significant than in the case of FIG. 5. In fact, we see that in the zone of strongest deformation, there is a sliding of the layer 5 of TiN in the deformed zone, which leaves the layer 4 of Ti covering only the substrate 3 in the zone of initiation of the deformation. Without the presence of the Ti layer 4, the substrate 3 would have been found to be bare in this zone of greatest deformation and gradually it could have released into the electrolyte contaminating atoms for the cation exchange membrane. The persistent presence in this zone of the ductile layer 4 of Ti according to the invention makes it possible to avoid this drawback.

As we have said, the example shown in the figures and commented on is in no way limiting. The SUS 316L substrate may be replaced by any stainless steel capable of constituting a bipolar plate. The Ti coating may be replaced by any metallic coating, consisting of a pure metal or an alloy, with preferred examples, in addition to Ti, Cr, Al and stainless steels.

Optionally, two or more layers of different metals or alloys may be deposited successively before the deposition of the upper conductive layer. The different layers would preferably have different ductilities which would lead to the establishment of a ductility gradient within the deposit (the ductility gradually approaching that of the upper conductive layer) thus ensuring a “smooth transition” of the ductility of the deposit, which would be more favorable to its good resistance during deformation. Also, it may be ensured that the metal or alloy deposited first on the substrate preferably has an excellent capacity to adhere to the substrate, whereas it would have a lower capacity to adhere to the upper conductive layer, and that the material last deposited before the deposition of the upper conductive layer has, itself, a lower capacity to adhere to the substrate, but a better capacity to adhere to the conductive layer than the material deposited first. If, on the other hand, these two metallic materials have an excellent ability to adhere to one another (for example through diffusion of one into the other or any other mechanism), optimal adhesion of the various materials to each other is obtained.

The invention also relates to a fuel cell of the PEMFC type and the units which compose it, conventionally comprising bipolar plates to ensure the assembly between them of the units of the cell, at least one of said plates, and preferably all of said plates of all said units, being constituted according to the present invention.

1. Bipolar plate for assembling the elements of a fuel cell unit, consisting of a stainless steel substrate coated on at least one of its two faces with a layer of an electrically conductive material, wherein said material is chosen from CrN and a bivalent or trivalent Ti compound or a mixture of such compounds, in that if said electrically conductive material is a divalent or trivalent Ti compound or a mixture of such compounds, said layer contains at most an amount of oxygen in at. %, measured by X-ray Photoelectron Spectrometry (XPS) over the upper 10 nm of said layer, which does not exceed 1.5 times the at. % oxygen content which, according to the measured at. % Ti content, would correspond to a coating which would be entirely composed of TiO, and in that between said substrate and said layer of electrically conductive material is interposed at least one intermediate layer (4) of a metal or a metallic alloy, the thickness of said layer of metallic material being at least 1 nm over the entire surface of the substrate.

2. The bipolar plate according to claim 1, wherein said metal or metal alloy is chosen from Ti, Al, Cr, alloys based on Ti or Al or Cr, a stainless steel.

3. The bipolar plate according to claim 1, wherein the ductility of at least one layer of a metal or metal alloy is intermediate between that of the substrate and that of the layer of a compound or of a mixture of divalent Ti compounds.

4. The bipolar plate according to claim 1 further comprising several superposed intermediate layers, wherein the respective ductilities of said superposed layers create a ductility gradient within the layers, the respective ductilities of said superimposed intermediate layers gradually approaching that of the layer of conductive material.

5. The bipolar plate according to claim 1, wherein said Ti compound, if it is bivalent, is chosen from TiN, TiO and mixtures thereof.

6. The bipolar plate according to claim 1, wherein the two faces of said plate are each coated with a layer of at least one bivalent or trivalent Ti compound, each of said layers containing at most one quantity of oxygen, measured by X-ray Photoelectron Spectrometry (XPS) on the upper 10 nm of said layer, which does not exceed 1.5 times the at. % of oxygen content which, according to the at. % of measured Ti content, would correspond to a coating which would be entirely composed of TiO.

7. Bipolar plate according to claim 1, wherein the conductive layer of one of the faces of the plate is a bivalent or trivalent Ti compound or a mixture of such compounds, containing at most an amount of oxygen, measured by X-ray Photoelectron Spectrometry (XPS) on the upper 10 nm of said layer, which does not exceed 1.5 times the at. % of oxygen content, which, according to the measured at. % of Ti content, would correspond to a coating which would be entirely composed of TiO, and in that the conductive layer on the other face is CrN.

8. A method of manufacturing a bipolar plate for assembling the elements of a fuel cell unit, consisting of a stainless steel substrate coated on at least one of its two faces with a material conductor of electricity, wherein said material is chosen from CrN and a compound of divalent or trivalent Ti or a mixture of such compounds, in that said layer, if it consists of a compound of bivalent or trivalent Ti, or of a mixture of such compounds, contains at most an amount of oxygen, measured by X-ray Photoelectron Spectrometry (XPS) on the top 10 nm of said layer, which does not exceed 1.5 times the at. % of oxygen content which, according to the measured at. % of Ti content, would correspond to a coating which would be entirely composed of TiO, and in that:
a stainless steel substrate is provided in the form of a strip or sheet;
at least one layer of a metal or a metal alloy, at least 1 nm thick, is deposited on at least one of the faces of the substrate, over the entire surface of the substrate;
there is deposited on at least said face of the plate a layer of a compound or a mixture of compounds of bivalent Ti by Physical Vapor Deposition (PVD) in a deposition installation comprising at least one deposition chamber, means for causing the substrate to scroll inside said chamber in a longitudinal direction, means for limiting or controlling the quantity of air and oxygen introduced into the chamber, and at least one Ti target;
and cutting and shaping said substrate thus coated to give it the desired shape and dimensions and obtain a bipolar plate for fuel cell.

9. The method according to claim 8, wherein said metal or metal alloy is chosen from Ti, Al, Cr, alloys based on Ti or Al or Cr, a stainless steel.

10. The bipolar plate according to claim 1, wherein the ductility of the at least one layer of a metal or metal alloy is intermediate between that of the substrate and that of the layer of a compound or a mixture of bivalent Ti compounds.

11. The method according claim 8, wherein several intermediate layers are superposed, and in that the respective ductilities of said superposed intermediate layers create a ductility gradient within layers, the respective ductilities of the intermediate layers gradually approaching that of the layer of conductive material.

12. The method according to claim 8, wherein said Ti compound, if it is bivalent, is chosen from TiN, TiO and mixtures thereof.

13. The method according to claim 8, wherein one of the faces of the substrate is coated with a conductive material consisting of a compound of divalent or trivalent Ti or a mixture of such compounds, and in that the other face is coated with a conductive material consisting of CrN.

14. An unit for a PEMFC type fuel cell, composed of an anode/electrolyte/cathode assembly, the anode and the cathode comprising at least one bipolar plate comprising a stainless steel substrate coated on at least one of its faces by an electrically conductive material, wherein at least either the anode or the cathode comprises at least one bipolar plate according to claim 1.

15. A fuel cell comprising units of bipolar plates for assembling the elements of its units, wherein at least one of said units is the unit according to claim 14.

16. The bipolar plate according to claim 1, wherein the thickness of said layer of metallic material is at least 5 nm.

17. The bipolar plate according to claim 1, wherein the thickness of said layer of metallic material is at least 15 nm.

18. The method according to claim 8, wherein said at least one layer of a metal or a metal alloy is at least 5 nm thick.

19. The method according to claim 8, wherein said at least one layer of a metal or a metal alloy is at least 15 nm thick.
